(19) United States
(12) Patent Application Publication
(10) Pub. No.: US 2008/0301573 A1
(43) Pub. Date: Dec. 4, 2008

(54) SYSTEM AND METHOD FOR INDICATING PAGE COMPONENT FOCUS

(76) Inventor: Liang-Yu Chi, San Francisco, CA (US)

Correspondence Address: YAHOO! INC.;C/O DREIER LLP, 499 PARK AVENUE, NEW YORK, NY, 10022, US

(21) Appl. No.: 11/755,146

(22) Filed: May 30, 2007

(51) Int. Cl. G06F 3/048

(52) U.S. Cl. 715/771

(57) ABSTRACT

The present invention relates to systems and methods for providing content items containing components utilizing focus indication focus indication. The method according to one embodiment comprises receiving a request from a client by a content delivery network for a resource that comprises a plurality of resources. The plurality of resources are then concatenated at the content delivery network to generate a concatenated resource and propagated to the client through the content delivery network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to rendering and presenting content items. More specifically, the invention relates to identifying one or more components that are part of a content item and providing a visual indication when a given one of the one or more components receives user focus such that the given component is isolated from components that do not have user focus.

### BACKGROUND OF THE INVENTION

Internet search portals provide an increasingly convenient method of using the vast wealth of information present on the World Wide Web. As more information is available for users, however, it is nearly unavoidable that information may be lost in the presentation of the available information. For example, common search portals contain a plurality of elements in addition to the standard search box element. Many portals contain news elements, mail elements, links to other portal services, a directory listing of sites and various other elements.

As the amount of materials available on a given portal increases, it becomes difficult for a user to focus clearly on a particular element. For example, it may not be readily clear where elements start or stop. Similarly, advertising or attractive content can distract users from focusing on one or more given tasks. If a search portal loses its user friendly aspect, the usage of the portal may decline and result in a loss of advertising revenue (among many other sources of revenue) for the search engine, thus decreasing the profitability of the portal.

Current techniques to cure this cluttering of information include providing the user with the option of utilizing a standard portal containing the extra elements or a “bare bones” version of the portal that may contain only a search element. This solution reduces the confusion of a modern search portal, but sacrifices many beneficial aspects of the portal that users may wish to utilize.

Thus, there is a need in the art for systems, methods and computer program products that, in the context of a content item comprising one or more components or otherwise disparate parts, provide a visual indication when a given one of the one or more components receives user focus, e.g., such as isolating the given component from components that do not have user focus.

### SUMMARY OF THE INVENTION

Embodiments of the present invention is directed towards methods, systems and computer readable media comprising program code for indicating focus on a given component or part of a content item. Embodiments of the present invention provide one or more focus modules within a content item that are operative to control focus indication on the basis of user interaction with the content item. The focus code module receives user input to determine a component (which may comprise a part or portion of the content item) that receives user focus and presents a visual indication to isolate the component in the content item when a display device presents the content item.

The use of a focus control module as described herein provides a number of advantages for viewing and interacting with a given content item. For example, when attempting to interact with a given component that is part of a content item, the focus control module may prevent user distraction by obscuring components that do not have user focus. In the context of a search engine, the focus module provides further benefit by preventing random eye tracking that tends to result in user confusion through the exposure to information on the page when the client device is awaiting receipt of a search result set for rendering. Similarly, using the focus module to focus user attention on a given component (e.g., a search query entry control) reduces user eye tracking to random locations on the page, which has the result of minimizing or otherwise reducing the mechanical eye-tracking path to view search the search result set on a subsequent page.

According to one embodiment, the invention is directed towards a method for providing content items containing components utilizing focus indication comprising receiving a request from a client by a content delivery network for a resource that comprises a plurality of resources. In a preferred embodiment a plurality of parameters may further be defined that may control the display of a plurality of resources.

The plurality of resources may be concatenated at the content delivery network to generate a concatenated resource. In a preferred embodiment, the plurality of resources may be able to be focused or unfocused based upon user interaction. Furthermore, when one of the plurality of resources are focused, the remaining resources may remain unfocused. In one embodiment, the focusing and unfocusing comprises unfading and fading respectively. In an alternative embodiment, the focusing and unfocusing may comprise removing all resources except for the focused resource. Additionally, one of the plurality of resources may include a focus fade program. Finally, the concatenated resource is then propagated to the client through the content delivery network.

The present invention is further direct to a system for providing content items containing components utilizing focus indication comprising a plurality of client devices communicatively coupled to a network and a content provider coupled to said network comprising a data store and a content server.

The data store may be operable to store content and at least one focus program module and the content server may be operable to generate a plurality of components from the content and to generate a final content item combining the components and focus program module.

In a preferred embodiment, the plurality of components are able to be focused or unfocused based upon user interaction. Furthermore, when one of a plurality of components are focused, the remaining components are unfocused. In one embodiment, the focusing and unfocusing comprises unfading and fading. In an alternative embodiment, the focusing and unfocusing comprises removing all resources except for the focused resource. Additionally, a plurality of parameters may be defined controlling the display of each component.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for focus indication according to one embodiment of the present invention;

FIG. 2 presents a flow diagram illustrating a method for focus indication according to one embodiment of the present invention;

FIG. 3 presents a flow diagram illustrating a method for generating a content item to support focus indication according to one embodiment of the present invention;

FIG. 4 presents a flow diagram illustrating a method for displaying a focused search box component according to one embodiment of the present invention.

FIG. 5 is a screen diagram illustrating a web page comprising one or more components according to one embodiment of the present invention; and

FIG. 6 is a screen diagram illustrating a web page in which a given component comprising the web page receives user focus according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

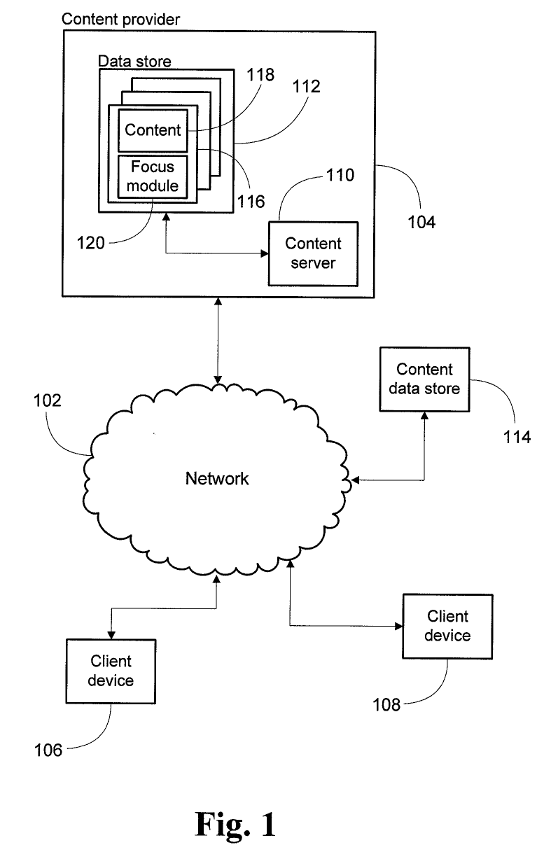

FIG. 1 presents a block diagram depicting a system for focus indication according to one embodiment of the present invention. According to the embodiment illustrated in FIG. 1, one or more client devices 106 and 108 are communicatively coupled to a network 102, which may include a connection to one or more local and wide area networks, such as the Internet. According to one embodiment of the invention, a given client device 106 and 108 is general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A given client device 106 and 108 may be in communication with a content provider 104 that hosts one or more content items 116. The content provider 104 may maintain one or more content servers 110, a given content server 110 hosting one or more web pages. The content provider 104 may also comprise a repository for the storage and transmission of one or more content items 116 in response to a request from a client device 106 and 108. For example, the content provider 104 may comprise a web site that includes a content server 110 (e.g., Apache™, Internet Information Server™, etc.) and a data store 112, which according to one embodiment is a database that maintains web pages in an organized and structured manner. The content provider 104 may further maintain program code that, when executed by the content provider 104, is operative to dynamically generate one or more content items.

A given client device 106 and 108 in communication with the content provider 104 requests a content item 116 that a content server 110 maintains at the content provider 104. Typically, the content server 110 maintains dynamic information at the content provider 104 for delivery to a client device 106 and 108. For example, where the content server 110 is using the content provider 104 to host one or more web pages, the content provider 104 may provide the HTML or page markup to a given client 106 and 108, which the content provider 104 may generate dynamically on the basis of program or scripting code that the content server 110 maintains at the content provider 104, e.g., Active Sever Page or Java Server Page code.

A resultant page that the content provider 104 provides to a client 106 and 108 may have links or references to one or more items of static resources for inclusion in the page and rendering by the client 106 and 108. Exemplary resources that a content item may comprise include, but are not limited to, JavaScript files, Cascading Style Sheets, images, video and audio. The content delivery network 102 is operative to host these resources, which links or references in a given content item instruct the client 106 and 108 to retrieve from the content delivery network 102.

As illustrated in FIG. 1, a content provider 104 contains a data store 112 containing a plurality of content items 116, a given content item 116 comprising content 118 and a focus module 120. In accordance with one embodiment, the content 118 contained in data store 112 may comprise HTML code comprising multiple components. For example, an HTML page corresponding to a search portal home page may contain a search box component, directory listing component, news ticker component and so forth.

Focus module 120, which may form part of the content item 116, contains program code operative to supply a display indication of focus for a given component and to remove focus from components. In accordance with one embodiment, focus module 120 may be implemented using JavaScript or any similar language. The focus module 120 is operative to respond to interaction received from a client device, such as mouse movements, keyboard actions, etc. Although illustrated within content item 116, focus module 120 may be resident in various other locations such as data store 112 or content data store 114 and may be referenced by content item 116 via an external request.

Content provider 104 may be operative to generate the content items 116 located within the data store 112. According to one embodiment, content 118 is located independently from the focus module 120. Upon locating the independent content, content provider 104 may be operative to select one or more components resident within the content 118 and apply the focus module 120 to one or more components within the content 118. For example, if the content 118 comprises and HTML comprising or otherwise identifying one or more components, the content provider 104 may be operative to select a given component and attach a JavaScript event handler that enables the given component to communicate its focus state (e.g., interaction with the client) to the focus module 120. The content provider 104 may then be operative to insert the focus module 120 into the content item 116, the focus module 120 operative to receive messages from the components and communicate appropriate actions to each component.

The content server 110 is operative to retrieve a content item 116 and provide the content item to a client device 106, 108. When a content item 116 is received by a client 106, 108, the focus module 120 monitors user interaction with the components that are part of the content 118 or the content item 116. In accordance with one embodiment, a component may detect a user interaction such as a mouse click or key press. The component may then indicate to the focus module 120 that an event has occurred. In one embodiment, the component may send the action performed, although alternative embodiments exist wherein the message sent to the focus module 120 is simply an indication that any action has occurred.

After the focus module 120 receives the message from a given component, a determination is made as to subsequent actions to be taken. For example, if a message is received by the focus module 120 that indicates that a search box component has been activated, the focus module may send a message to other components instructing the other components to obfuscate their contents, for example, by modifying their opacity. Additionally, focus module 120 has the capability to brighten all components within a content item 116. For example, if a user selects the background of a content item 116, the focus module 120 may receive a message that none of the components are currently selected (e.g., no individual component has user focus) and thus displays all components at normal opacity.

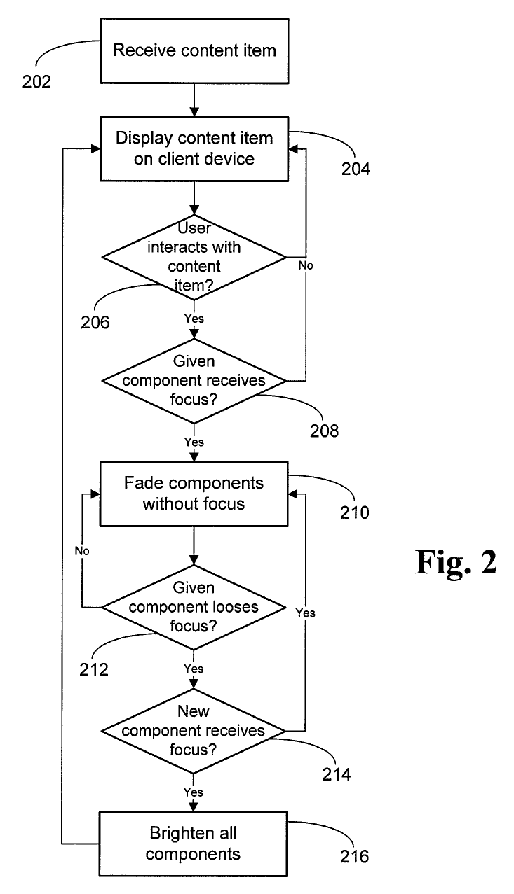

FIG. 2 presents a flow diagram illustrating a method for focus indication according to one embodiment of the present invention. According to the embodiment illustrated in FIG. 2, a client device receives a content item, step 202. The content item that the client receives in step 202 may be a resource commonly transmitted across data network such as the Internet. Common content items may include HTML pages containing components displayed via HTML; for example, a search portal may comprise a content item containing a plurality of components such as a search box, an advertisement component, a directory listing and a real-time news component.

A client device displays that content item that it receives, step 204. In accordance with one embodiment, a client device may utilize a web browser such as Microsoft Internet Explorer, Mozilla Firefox, or Opera to render and display content items received from an external or internal source. Alternative embodiments may exist wherein other client devices are utilized to display content including, but not limited to, hand held devices, set top terminals, mobile handsets, PDAs, etc.

The client device displays the content item on a display device, step 204, and program code monitors the content item for an interaction by the user, step 206. According to one embodiment, the content item may be monitored via JavaScript event handlers, such as “onmouseover”, “onmousedown”, “onkeypress”, “onclick”, etc. As known in the art, JavaScript event handlers allow a programmer to define actions to occur whenever specific states are initiated by a user. For example, the “onmouseover” event handler may be attached to a custom function, wherein when a user hovers his or her mouse pointer over a specified component the custom function is called and executed. If a user does not interact with a content item, the content item remains idle and waiting for an interaction event. If the user interacts with a given content item a check is performed to see if a component within a content item was given focus.

The content item may comprise multiple components that may receive focus, thus a determination must be made as to when a given component initially gains focus, and ignore the interaction wherein the focus still remains within the current component. For example, if the component already has focus and a user merely interacts with another element within the component, the process returns to step 204 and waits for an initial change in focus. However, if it is determined that a user interacts with a component for the first time, all other component will be faded to “illuminate” the focused component, step 210.

Other component comprising the content item that do not have focus are faded, step 210. For example, in an HTML page, components not in focus may be adjusted by modifying a Cascading Style Sheet selector associated with the unfocused components. Alternatively, JavaScript may be utilized to dynamically modify the style assigned to each component. Alternative methods of drawing focus away from the unfocused components may be utilized such as minimizing the unfocused components, moving components to the side of a resource, cascading unfocused components, etc.

While a component is in focus, a check determines if the focused component loses its focus, step 212. If the component remains in focus, the other unfocused components remain obfuscated; if the component loses focus, such as by a user selecting a different component, a check is performed to determine if a new component receives focus, step 214.

If a new component receives focus, other unfocused components are obfuscated, step 210. If focus is switched to an element other than a component, all component are unobfuscated, step 216. For example, a client may select the background of an HTML page which may not be a component that can receive focus, thus all components on the HTML page are brightened.

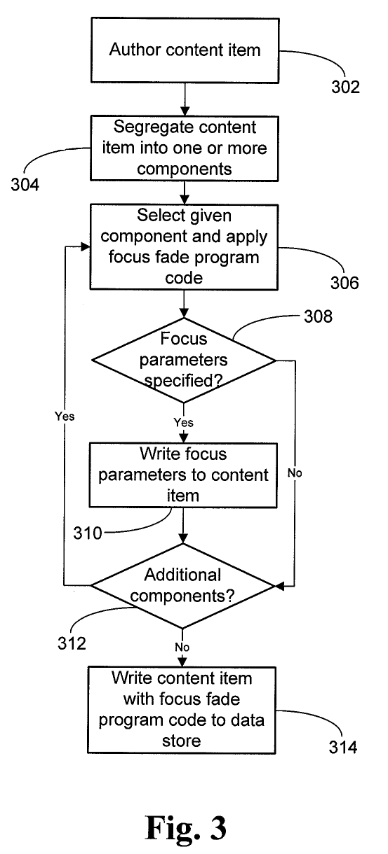

FIG. 3 presents a flow diagram illustrating a method for generating a content item to support focus indication according to one embodiment of the present invention. Accordingly, a user may author a content item, step 302. As previously mentioned, a content item may be a static or dynamically generated HTML page or similar content item containing multiple components such as a search box, real time news ticker, directory listing, etc.

A content item is segregated into one or more components, step 304. For example, continuing the previous example, a user may partition a content item into multiple components corresponding to a search box component, news ticker component, directory listing component, etc. After separating the content item into one or more components, the user selects a given component and a focus program code is applied thereto.

The application of a focus program code may comprise attaching JavaScript event handlers to the given component. For example, the given component within a content item may have an attached JavaScript event handler such as “onmouseover” that points to a focus program code. The use of event handlers and a global program code allows all components to quickly be attached to the focus program code, thus speeding up the processing time of the invention.

Focus parameters may also be specified for a selected component, step 308. Focus parameters for a selected component may be variable controlling how a component is to display when it receives focus or looses focus. For example, a focus parameter may specify the opacity of a component during its focused/unfocused state or its position during those states. If the focus parameters are present for a particular component, these parameters are written to the component, step 310. In one embodiment, focus parameters may be written as parameters within a custom function for a given event handler. For example, the attribute onmouseout=“unfocus(10)” may specify that when a user moves the mouse away from a component, the opacity of the component will be reduced to 10%. Alternatively, focus parameters may be written to the parent content item, for example, within the global focus code. According to this embodiment, a component may call the focus and unfocus commands and the focus program code retrieves the parameters associated with the call. After the parameters are written, or after it is determined that no parameters exists, any remaining components are inspected, step 312.

If all components have been inspected, the content item is written to a data store along with the focus program code, step 314. In one embodiment, the focus program code and content item may be merged to form one item. In an alternative embodiment, the focus program code and content item may be stored as two separate items, the content item referencing the external program code.

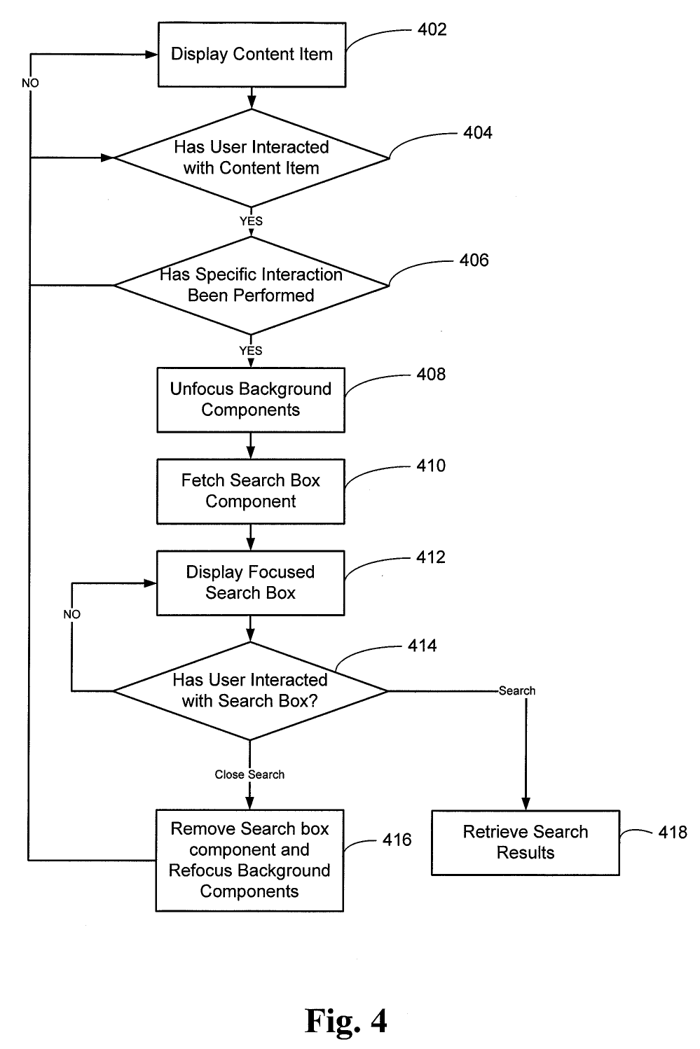

FIG. 4 presents a flow diagram illustrating a method for displaying a focused search box component according to one embodiment of the present invention. Accordingly, a content item is displayed, step 402. According to various embodiments, the display of a content item may comprise displaying a statically or dynamically generated HTML page by a browser executing on a client device.

A check is performed to determine if the user has interacted with the content item, step 404 and subsequently, if the user has performed a specific action, step 406. If the user has not interacted with the content item, or has not performed the specified action for which the method is monitoring, the browser continues to display the content item, step 402. According to one embodiment, the user interaction being monitored may be a key stroke, such as CTRL-Y. According to alternative embodiments, the user interaction may be a plurality of other user interactions such as a mouse clicks, mouseover event, etc. The choice of interaction method may be determined prior to the display of the content item, such as by a server administrator, programmer, algorithm or any other means capable of configuring the content item.

If a user has performed the specified action, components on the page are unfocused, step 408. According to one embodiment, a content item may contain a plurality of components, such as content stored with HTML DIV tags. When a user performs the appropriate action, such as a keystroke, a display setting for a given component may be adjusted to cause the components to darken, fade or otherwise become visually obscured.

The background components are unfocused and a search box component may be retrieved, step 410. A new component may be generated by the client device, such as by a browser. Alternatively, a request may be sent to a remote device to retrieve the component, such as via an asynchronous request for data. The retrieved search box component may comprise a text box and control elements such as a close button. The search box component is then displayed on the client device and given focus, step 412. As previously mentioned, receiving focus may cause the search box element to be brighter than the background components comprising the content item.

A check is then performed to determine if a user has interacted with the search box component, step 414. If the does not interact with the search box component, the component remains on the display and maintains focus, step 412. If a user interacts with the search box by submitting a search query, the search results are retrieved, step 418. For example, a search box component may contain a textbox and a search button enabling a user to enter a search query and submit the request to a search engine. Upon this user interaction, the client may retrieve a new page comprising the search results for display, resulting in the previous content item no longer being displayed on the display of the client device.

If a user interacts with the search box component by indicating the closure of the component, search box component is removed and the background components are refocused, step 416. According to one embodiment, a search box component may comprise a close button or link similar to that of a close button present in an application. After a search box component is displayed, a user may decide that he or she does not wish to enter a search query and may decide to close the displayed search box component. In one embodiment, if a user selects to close the search box component the component may be removed by a client side method, such as the document.removeChild method that the JavaScript scripting language provides. After removing the search box component from the user display, background components are brought back into focus and the state of the content item is returned to the original state, step 402.

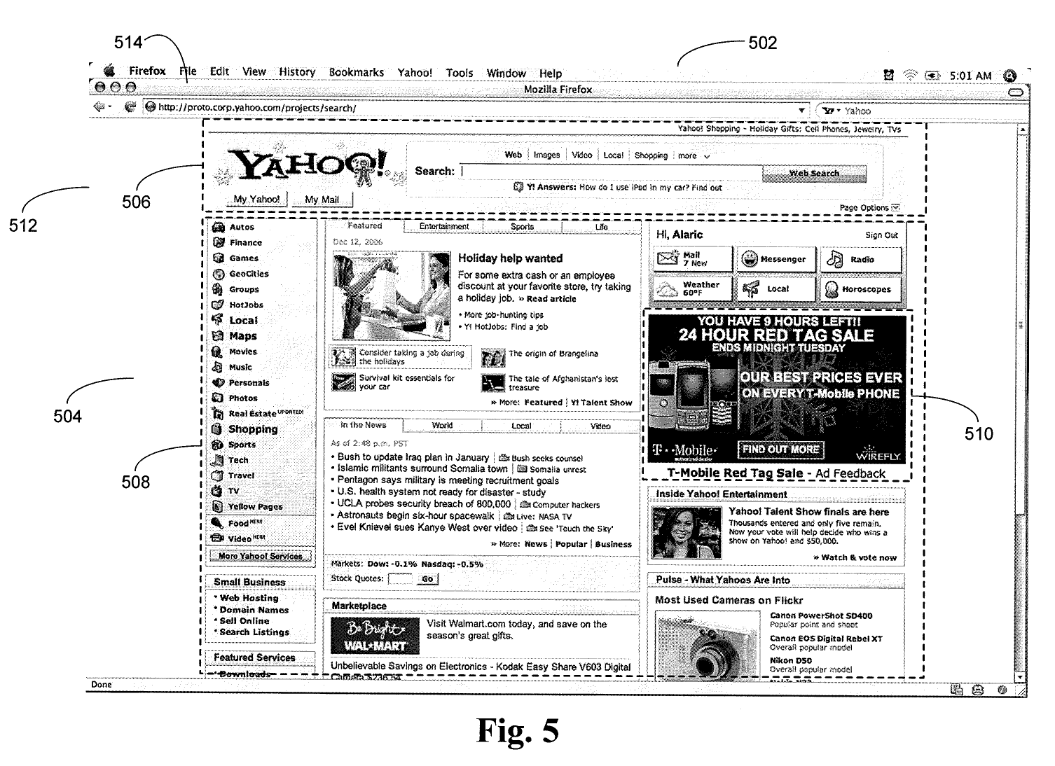

FIG. 5 presents a screen diagram illustrating a web page comprising one or more components according to one embodiment of the present invention. FIG. 5 illustrates a browser 514 running on a client device 502 and viewing a Yahoo! search portal content item 512. FIG. 5 shows the search portal after its initial load from a server.

As illustrated in FIG. 5, search portal 512 may comprise at least two components 506 and 508. Component 506 corresponds to a component allowing a user to enter search queries and submit them to a search engine. Component 508 comprises the remainder of the search portal content. Alternatively, many more components may be defined within the content item, such as an advertisement component 510.

The components illustrated in FIG. 5 may be contained within an HTML DIV element. An HTML DIV elements specifies a section or block element within an HTML page. The use of a DIV element allows a page author to logically divide a webpage into sections, aiding in the creation of the components 506, 508, and 510. Furthermore, FIG. 5 illustrates how components may have multiple items that may receive focus. For example, component 506 comprises a textbox and multiple buttons, all of which are capable of signaling focus has been received by an element within the component.

In addition to the components illustrated by 506, 508, and 510, a content item contains a non-component background, 504. As previously stated, this item may not comprise focus program code to enable to focusing and unfocusing of the element, as it is merely the background and does not interact with the user.

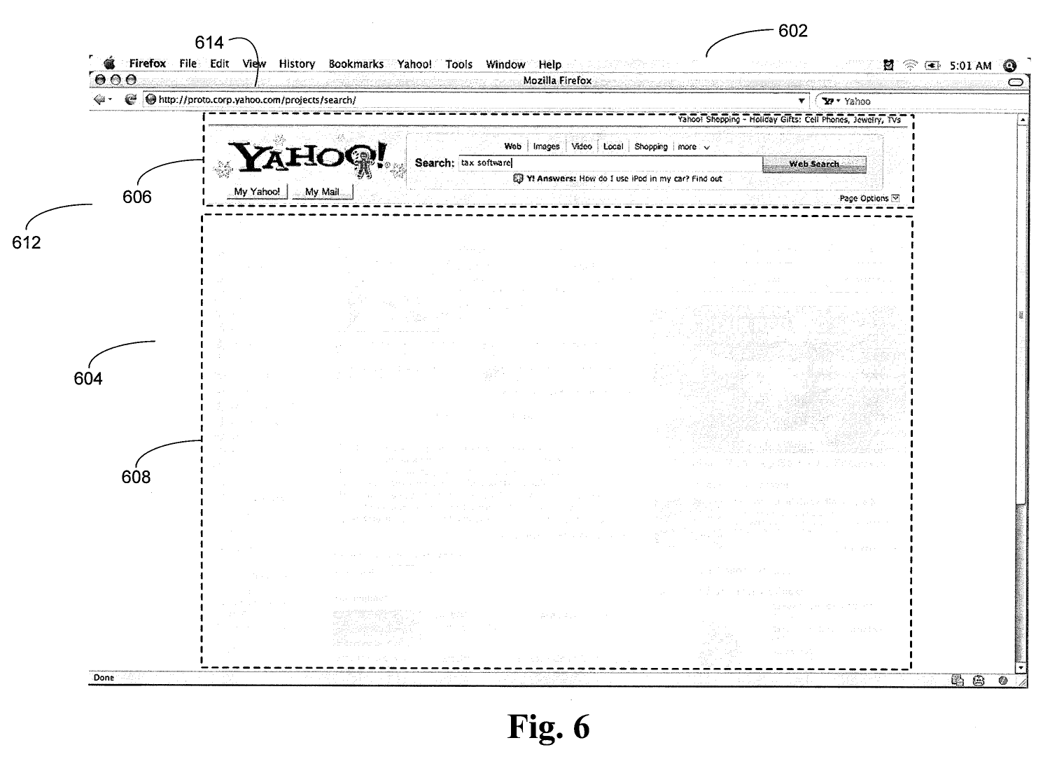

FIG. 6 is a screen diagram illustrating a web page in which a given component comprising the web page receives user focus according to one embodiment of the present invention. Accordingly, FIG. 6 illustrates a browser 614 running on a client device 602 and viewing a Yahoo! search portal content item 612. FIG. 6 shows the search portal after an element has received focus.

As illustrated in FIG. 6, component 606 receives focus from the user. In this example, a user entered the text “tax software” into the search textbox present within component 606. Accordingly, when the component 606 receives focus, other components 608 present within content item 612 are faded enough to draw attention (in this example, the only other component is 608, however, an identical result may be obtained had there been other components present within the content item). If a user were to click on the background of the content item (604), the state of the content item returns to the state illustrated in FIG. 5. That is, all components within the content item become illuminated and clearly visible.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for providing content items containing components utilizing focus indication, the method comprising:
receiving a request from a client for a content item that comprises a plurality of resources;
generating a plurality of components corresponding to said plurality of resources;
generating a focus fade program; and
combining said plurality of components to form a single content item.

2. The method of claim 1, wherein the plurality of components are able to be focused or unfocused based upon user interaction.

3. The method of claim 2, wherein when one of a plurality of components are focused, the remaining resources remain unfocused.

4. The method of claim 3, wherein focusing and unfocusing comprises unfading and fading.

5. The method of claim 3, wherein focusing and unfocusing comprises removing all resources except for the focused resource.

7. The method of claim 1, wherein a plurality of parameters may be defined controlling the display of said resources.

7. A system for providing content items containing components utilizing focus indication comprising:
a plurality of client devices communicatively coupled to a network; and
a content provider coupled to said network comprising:
a data store operable to store content and at least one focus program module; and
a content server operable to generate a plurality of components from said content and to generate a final content item combining said components and said focus program module.

8. The system of claim 9, wherein the plurality of components are able to be focused or unfocused based upon user interaction.

9. The system of claim 10, wherein when one of a plurality of components are focused, the remaining components remain unfocused.

10. The system of claim 9, wherein focusing and unfocusing comprises unfading and fading.

11. The system of claim 9, wherein focusing and unfocusing comprises removing all resources except for the focused resource.

13. The system of claim 7, wherein a plurality of parameters may be defined controlling the display of said components.

14. Computer readable media comprising program code that when executed by a programmable processor causes the processor to execute a method for providing content items containing components utilizing focus indication, the program code comprising:
program code for receiving a request from a client for a content item that comprises a plurality of resources;
program code for generating a plurality of components corresponding to said plurality of resources;
program code for generating a focus fade program; and
program code for combining said plurality of components to form a single content item.

15. The computer readable media of claim 14, comprising program code to focus or unfocus the plurality of components based upon user interaction.

16. The computer readable media of claim 15, comprising program code to cause the remaining resources remain unfocused when one of a plurality of components are focused.

17. The computer readable media of claim 16, wherein the program code for focusing and unfocusing comprises program code for unfading and fading.

18. The computer readable media of claim 16, wherein the program code for focusing and unfocusing comprises program code for removing all resources except for the focused resource.

19. The computer readable media of claim 14, comprising program code for defining a plurality of parameters to control the display of said resources.
